(19) United States
(12) Patent Application Publication
(10) Pub. No.: US 2005/0100875 A1
(43) Pub. Date: May 12, 2005

(54) Method and system for preventing illiteracy in struggling members of a predetermined set of students

(76) Inventors: Emery Randolph Best, Dallas, TX (US); Jeri Anne Nowakowski, Plano, TX (US); Matthew Peter Hunter, Dallas, TX (US); Stephan Randal Black, Colleyville, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/936,386

(22) Filed: Sep. 8, 2004

Related U.S. Application Data
(63) Continuation-in-part of application No. 10/718,170, filed on Nov. 20, 2003.
Application No. 10/718,170 is a continuation of application No. 10/124,587, filed on Apr. 17, 2002, now Pat. No. 6,676,413.

(51) Int. Cl. G09B 17/00

(52) U.S. Cl. 434/362; 434/350; 434/322

(57) ABSTRACT

A method and system for identifying a set of students who have encountered reading difficulty and are performing below grade level and intervening to prevent illiteracy and achieving grade-level literacy of struggling students. Standardized oral fluency assessments are administered for a predetermined set of at least one student in a database in a computer system. Results from the standardized oral fluency assessments are recorded for each student of the predetermined set in a database in a computer system. A standardized predictive measure of literacy is calculated on the computer system for each student, wherein the standardized predictive measure of literacy is a composite of the results stored in the database for each student. Struggling members of the predetermined set are identified based on each standardized predictive measure of literacy. An individual report for each struggling member is presented on a visual medium in communication with the computer system. Struggling members of the predetermined set are provided with specific individual recommendations of targeted intervention instruction and amount of instructional time whereby grade-level literacy is achieved.

### CROSS-REFERENCE TO RELATED PATENT APPLICATIONS

This patent application is a continuation-in-part of copending U.S. patent application Ser. No. 10/718,170, entitled, “Method and System for Preventing Illiteracy in Substantially all Members of a Predetermined Set of Students,” and filed Nov. 20, 2003, which is a continuation of U.S. patent application Ser. No. 10/124,587, entitled, “Method and System for Preventing Illiteracy in Substantially all Members of a Predetermined Set,” and filed Apr. 17, 2002.

### FIELD

This disclosure pertains to literacy programs. The teachings of the disclosure are particularly, but not exclusively, useful for preventing illiteracy and achieving grade-level literacy in struggling members of a predetermined set of students, such as those students in kindergarten through eighth grade (K-8).

### BACKGROUND

In 1965 the National Institute of Child Health and Human Development (NICHD) initiated a research program on reading. A division of the National Institutes of Health, NICHD research focuses on protecting the health and welfare of our nation's children. They maintain the key factor in a child's health and well being is their education—particularly, and instrumentally, their ability to read in order to be successful in school and in life. Failure to read is associated with juvenile crime, teenage pregnancy, and dropping out of school. Illiteracy is as disabling to a child as any of the diseases against which we regularly inoculate.

Illiteracy is a social, economic, and health issue that affects children throughout our nation, but particularly impacts the poor. Only 14% of children from low-income families can read. These children will disproportionately end up unemployed and in prisons. 75% of unemployed adults are illiterate, 85% of juvenile offenders, and 60% of prison inmates. Illiteracy costs America over $250 billion a year.

While illiteracy is a costly American problem, it is not an inevitable one. Research over the past 30 years from NICHD proves that 95% of children can learn to read if taught early, deliberately, and effectively.

Learning to read is the single most important factor determining a child's success in school and progress in life. Reading skills established in the first years of school enable students' success throughout school and afterwards.

Previous literacy programs utilized written tests to measure reading skills in students. Such tests are administered at the beginning and end of the school year. In some cases, the teachers whose students are being tested may devise tests. Commercial tests are administered and the results reported for tabulation. Some weeks or months later, the results are delivered to the teacher. This type of program presents statistical measures of the results of administering those tests, as a way of documenting the overall reading level of the tested students at two points in time. Reports are given on the performance of all students tested; individual results are reported normatively; i.e., compared to other students. Such programs do not provide specific recommendations for improving the skills of lower-performing students. Additionally, such programs are not repeated throughout the school year to monitor the progress of students toward grade-level literacy.

Previous literacy programs have reported on the reading skills of students, but they have not provided directed instruction to address deficiencies nor have they included reporting on the performance of teachers in the improvement of those reading skills. Those programs that provide general suggestions for remedial instruction activities for students do not collect information on the application of those suggestions, to allow administrators to evaluate the teachers, as well as the students.

Previous classroom management systems for monitoring the grades of students throughout the school year have provided spreadsheets to enter traditional letter grades (i.e., A, B, C, D and F) for individual students. These grades are from the tests administered by the teacher in the normal course of the school year. The grades are collected throughout the school year, and the grade history of individual students can give the individual progress of those students. However, because the tests are not standardized, the results collected by one teacher cannot be aggregated with the results from other teachers.

As such, many typical literacy programs and classroom management programs suffer one or more shortcomings. Many other problems and disadvantages of the prior art become apparent to one skilled in the art after comparing such prior art with the present invention as described herein.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 is a flow chart of the method for preventing illiteracy and achieving grade-level literacy in substantially all members of a predetermined set of students;

FIG. 2 is a table of fluency measures and the reading skills they assess for;

FIG. 3A is an example of a teacher's instruction sheet for an oral fluency assessment;

FIG. 3B is an example of a worksheet for administering an oral fluency assessment;

FIG. 4A is an example of an oral fluency assessment results entry screen;

FIG. 4B is an example of a weekly progress monitoring results entry screen;

FIGS. 5A, 5B, 5C and 5D are example tables used for calculating a standardized measure of literacy from assessment results;

FIG. 6A is an example report of individual student assessment results and calculated predictive measure of literacy

FIG. 6B is an example report of recommendations of curriculum and instruction time;

FIG. 7 is an example timeline plot of assessment results for a student, including an indication of a target score representing grade-level literacy;

FIG. 8A is an exemplary aggregated report for a class;

FIG. 8B is an exemplary aggregated report of recommendations of curriculum and instruction time;

FIG. 9 is an exemplary aggregated report for a school;

FIG. 10 is an exemplary aggregated report for a school district;

FIG. 11 is an example of an implementation survey form;

FIGS. 12A and 12B are example supervisor survey forms;

FIG. 13 is an example of an implementation report;

FIGS. 14A and 14B illustrate an example of a school supervisor report;

FIG. 15 is an example of a district supervisor report;

FIG. 16 is a block diagram of a computer system embodying the present invention;

FIG. 17 is a block diagram of an Internet-based computer system embodying the present invention;

FIG. 18 is a diagram of screens and menu selections used in an embodiment of the present invention;

FIG. 19 is a flow chart of an alternate method for preventing illiteracy and achieving grade-level literacy in struggling members of a predetermined set of students;

FIG. 20 is a flow chart of another alternate method selectively utilizing Spanish-Language materials for preventing illiteracy and achieving grade-level literacy in struggling members of a predetermined set of students; and

FIGS. 21A and 21B depict progress monitoring benchmarks for implementation of an illiteracy prevention system at four levels, in accordance with an embodiment of the present invention.

### DETAILED DESCRIPTION

The present system is explicitly built to achieve the 95% goal and designed as a primary prevention system to identify all children in a predetermined group at risk for reading failure, to provide each one immediate intervention, to monitor student progress in the intervention, and to continue the intervention until every child is on track to become a reader. The system is designed to find and remediate the problem of illiteracy at its origin—in the critical developmental years—and then to eradicate it. The ability to ensure all literacy-capable children in America can read through a primary prevention system constitutes an economic, social, and health safeguard of significant proportion.

The present invention provides one minute standardized oral fluency assessments for determining the level of development of critical reading skills in individual students. These measures are 92% predictive of where a student will be at the end of the year absent intervention. Teachers can enter assessment results directly into the system and receive summary results immediately. The system may be made available over the Internet to teachers in any location. The oral fluency assessments are repeated throughout the school year for lower-performing students, to allow monitoring of those students' progress toward grade-level literacy. Specific recommendations of curriculum and instruction time may be made for each student, based on the measured reading skills of that student. The assessment results for individual students may be aggregated to provide summary reports for all students in a classroom, a school or a school district.

More specifically, aspects of the invention may be found in a method and system for preventing illiteracy and achieving grade-level literacy in substantially all members of a predetermined set of students. The method contains the steps of administering standardized oral fluency assessments to the students in the predetermined set of students. The results of those assessments are recorded in a database and a standardized predictive measure of the current level of literacy of individual students is calculated. A report is presented for each student showing the student's recorded results; a calculated measure of literacy; and recommendations of curriculum and instruction time, based on the student's calculated measure of literacy. The report may also include a timeline plot of the student's results through the school year, showing his/her progress toward grade-level literacy, which may also be plotted on the timeline. A schedule is also determined for each student, also based on the student's calculated measure of literacy, for repeating the steps of the method during the school year, in order to achieve grade-level literacy in substantially all members of the predetermined set of students.

Aggregate reports may be prepared, showing a summary of the progress of all students in the predetermined set of students. Where the predetermined set of students is all students in a school district, aggregate reports may be prepared for a subset of students in the district: e.g., all students in a single classroom, all students at a given grade level within a school, all students within a school.

Teachers may be surveyed for information regarding their activities in implementing the method of the present invention, and a report presented on that information, including recommendations to improve the teacher's implementation of the method. Information regarding professional development activities may be collected and reported on. Activities may also be specified for the supervisors of the teachers, and surveys used to collect information about the performance of those activities by the supervisors. Reports can be prepared on the information collected on such supervisory activities and recommendations of supervisory activities to improve the implementation of the method. Data entry screens and reports may be provided to teachers and administrators over the Internet.

Additionally, the present disclosure provides a method for identifying a set of students who have encountered reading difficulty and are performing below grade level and providing for intervention to prevent illiteracy and achieving grade-level literacy of struggling students. Standardized oral fluency assessments are administered for a predetermined set of at least one student. Results from the standardized oral fluency assessments are recorded for each student of the predetermined set in a database in a computer system. A standardized predictive measure of literacy for each student is calculated on the computer system. The standardized predictive measure of literacy is a composite of the results stored in the database for each student. Struggling members of the predetermined set are identified based on each standardized predictive measure of literacy. An individual report for each struggling member is presented on a visual medium in communication with the computer system. The individual report includes the results for the struggling member stored in the database, the standardized predictive measure of literacy for the struggling member, and recommendations of intervention curriculum and amount of instruction time for the struggling member based on the standardized predictive measure of literacy for the struggling member. A schedule is determined for performing the step of administering the standardized oral fluency assessments for the predetermined set of at least one student in the database in the computer system, based on the standardized predictive measure of literacy for each struggling member. The steps of administering, recording, calculating, presenting an individual report, determining according to the schedule, and providing targeted reading intervention instruction are repeated and as a result grade-level literacy is achieved in the struggling members of the predetermined set of students.

Moreover, the present disclosure teaches a system for identifying a set of students who have encountered reading difficulty and are performing below grade level and providing for targeted intervention instruction to prevent illiteracy and achieving grade-level literacy of said struggling students. The system includes standardized oral fluency assessments, a computer system, at least one input device and at least one output device. The computer system includes a database, calculation instructions, identification instructions, recommendation instructions, and scheduling instructions. The database is adapted for storing results of administering the standardized oral fluency assessments to a predetermined set of at least one student. The calculation instructions are adapted for calculating a standardized predictive measure of literacy for each student, wherein the standardized predictive measure of literacy is a composite of the results stored in the database for each student. The identification instructions are adapted for identifying struggling members of the predetermined set based on each standardized predictive measure of literacy. The recommendation instructions are adapted for recommending curriculum and amount of instruction time for each struggling member, based on the standardized predictive measure of literacy for the struggling member. The scheduling instructions are adapted for determining a schedule for administering the standardized oral fluency assessments for the struggling members. The input device is in communication with the computer system for inputting the results. The output device is in communication with the computer system for outputting the results, the measure of literacy, the targeted intervention instruction and amount of instructional time, and the schedule.

Furthermore, the present disclosure teaches a method for identifying a set of students who have encountered reading difficulty and are performing below grade level and providing for intervention to prevent illiteracy and achieving grade-level literacy of said struggling students. Results of standardized oral fluency assessments corresponding to a set of struggling students are requested. The results of the standardized oral fluency assessments corresponding to the set of struggling students are received. The results via an input device in communication with a computer system having a database are entered, thereby facilitating the recording of the results in the database in the computer system. An individual report for each struggling member is received via a visual medium in communication with the computer system. Each individual report includes the results for the struggling member stored in the database, a standardized predictive measure of literacy for the struggling member, wherein the standardized predictive measure of literacy is a composite of the results, and recommendations of targeted intervention instruction and amount of instruction time for the struggling member, based on the standardized predictive measure of literacy for the struggling member. A schedule for performing the step of requesting the results of the standardized oral fluency assessments for the set of struggling students is determined, based on the standardized predictive measure of literacy for each struggling member. The steps of requesting, receiving the results, entering, receiving via a visual medium, determining, and providing targeted intervention instruction and amount of instruction time are repeated according to the schedule and as a result grade-level literacy is achieved in the said struggling students.

As such, a system and method for preventing illiteracy and achieving grade-level literacy in substantially all members of a predetermined set of students is described. Other aspects, advantages and novel features of the present invention will become apparent from the detailed description of the invention when considered in conjunction with the accompanying drawings.

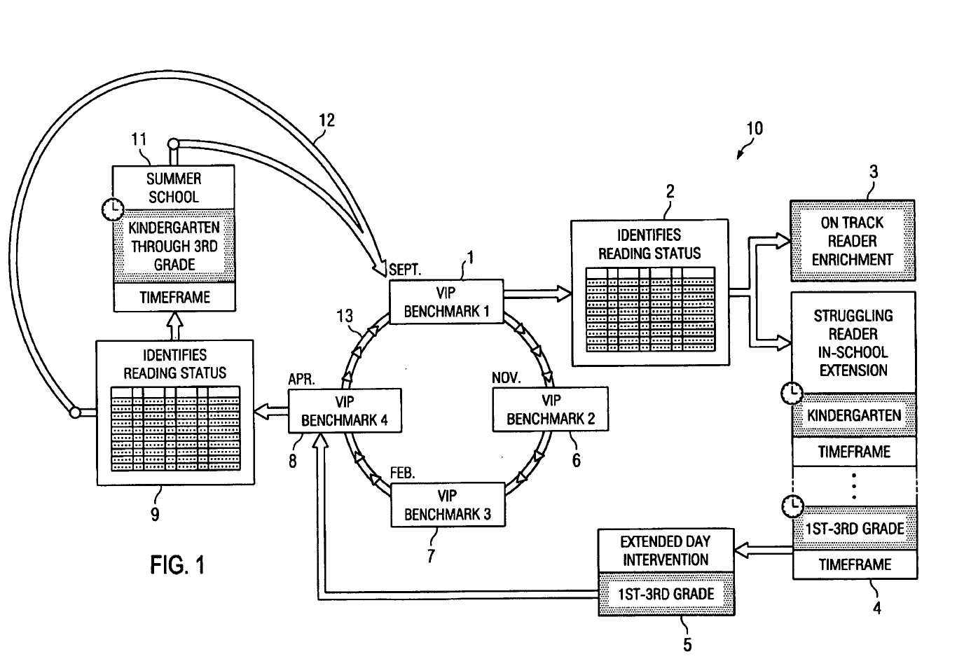

Preferred embodiments of the present invention are illustrated in the Figures, like numerals being used to refer to like and corresponding parts of the various drawings. FIG. 1 depicts illiteracy prevention method 10, an embodiment of the present invention. The assessments of benchmark period 1 are administered to kindergarten through third grade (K-3) students at the beginning of the school year to assess their initial levels of literacy during each of these years. An initial predictive measure of literacy 2 is calculated from the results of those assessments and used to make curriculum recommendations 3 for higher-performing readers. The initial measure of literacy is also used as the basis for extended instruction time recommendations 4 for lower-performing readers in kindergarten through third grade, and after-school instruction recommendations 5 for lower-performing readers in first through third grades. Weekly progress monitoring assessments 13 are administered to lower-performing readers in the periods between benchmark periods. Additional benchmarks 6, 7 and 8 are administered at intervals throughout the school year. Based on the final benchmark 8, a final calculated predictive measure of literacy 9 is used to characterize the reading skills of the students at the end of the school year. Based on that final assessment, summer school instruction recommendations 11 are made for lower-performing students, who receive extended instruction during the summer. Consequently, higher- and lower-performing students receive grade level promotions 12 and return to school the following year at the next grade level.

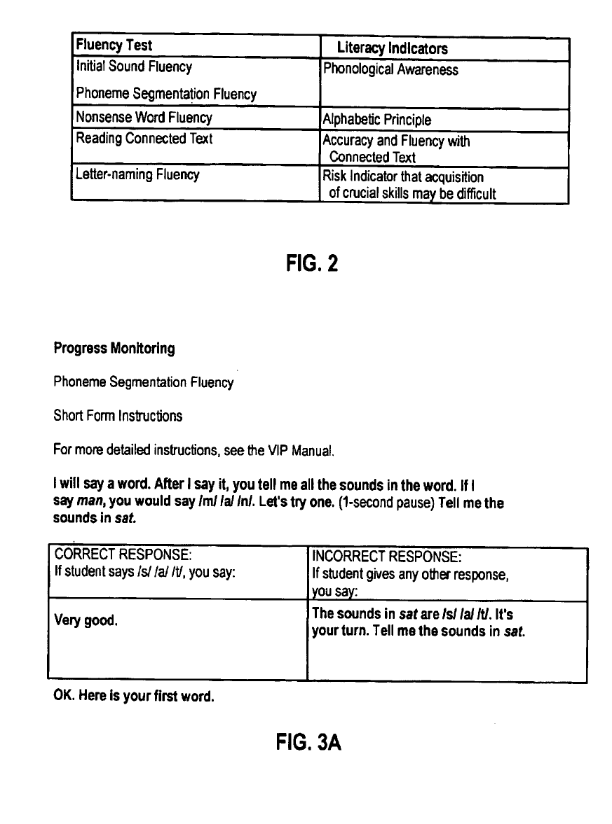

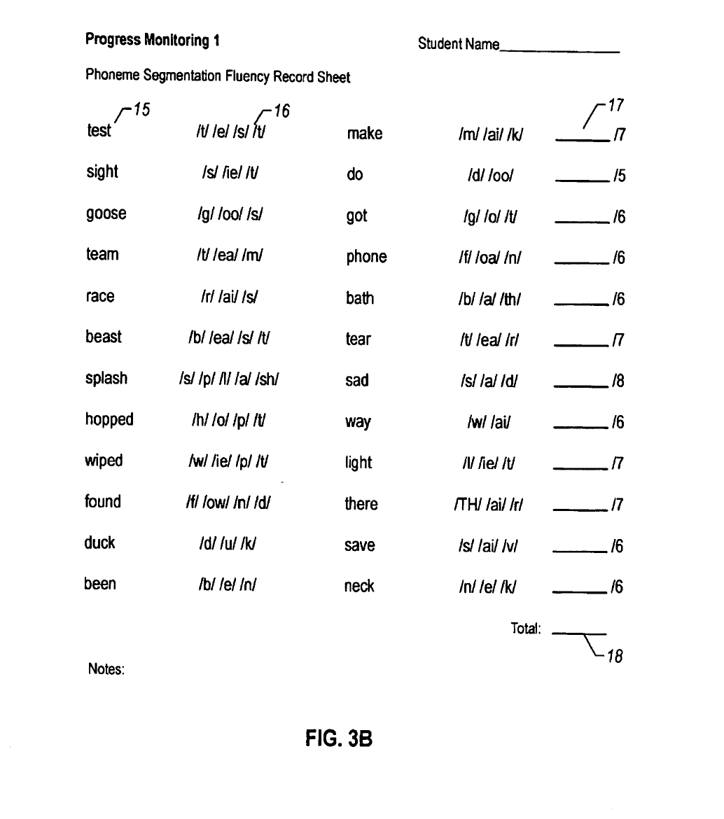

The benchmarks 1, 6, 7 and 8 and the weekly progress monitoring assessments 13 include orally administered fluency assessments. These measures assess critical reading skills that are predictive of a student's success in learning to read. The assessments are brief and unobtrusive, requiring only about one minute to administer. A table of example fluency assessments and the research-based, developmental literacy indicators for which they assessment are given in FIG. 2. For example, the Initial Sound Fluency and Phoneme Segmentation Fluency measures assess for Phonological Awareness. The Nonsense Word Fluency measure assesses for Alphabetic Principles. FIGS. 3A and 3B illustrate one such oral fluency assessment, in this case the measure for phoneme segmentation fluency. FIG. 3A depicts instructions and a script for the teacher to follow in administering the assessment. The teacher is given the script of a preparatory statement for the student, giving an example of a correct response and asking the student to respond to a practice word. The teacher is given samples of correct and incorrect responses to the practice word and scripts to use in reply to the student's response, correct or incorrect. FIG. 3B depicts a work sheet for administering an assessment to a single student. A series of assessment words 15 to be read to the student are listed, and the correct phoneme responses 16 for each assessment word are shown for the teacher's reference. Results of the assessment are entered into blanks 17 to record the student's performance on the assessment. In FIG. 3B, the results are the number of correct phonemes identified by the student out of the total number of phonemes presented by the assessment words. The results are totaled and entered into blank 18 for a single total score on the assessment.

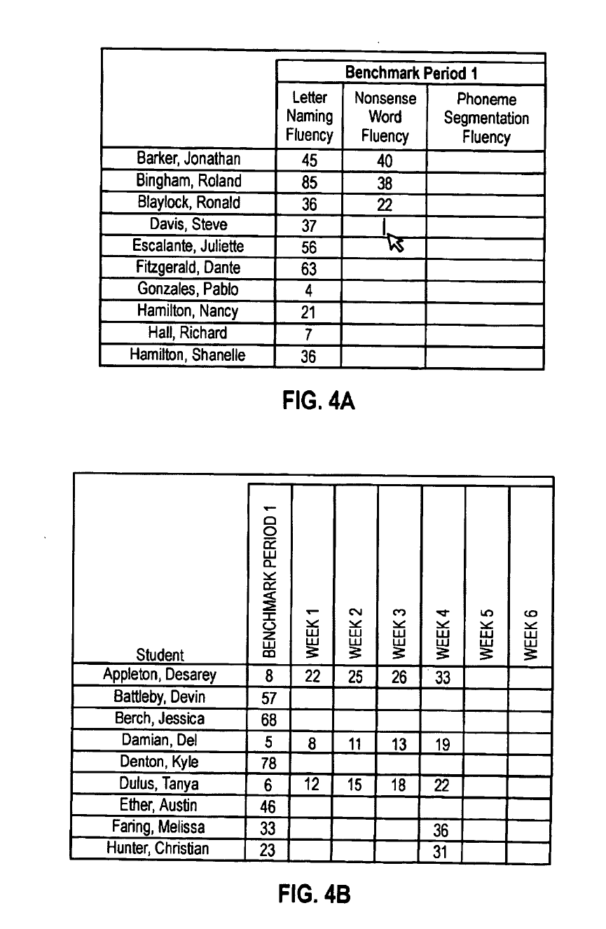

Multiple oral fluency assessments are administered as part of the benchmarks given throughout the school year, and FIG. 4A illustrates the entry of those assessment scores for one benchmark into the database of an embodiment of the illiteracy prevention method. Assessment scores from each of the oral fluency assessments are entered for each of the students in the class. In FIG. 4A, the fluency measures making up Benchmark 1 for first grade are Letter Naming Fluency, Nonsense Word Fluency, and Phoneme Segmentation Fluency. As indicated in the description of FIG. 1, lower-performing students are re-assessed weekly to monitor their progress toward improved literacy. FIG. 4B depicts a screen used for the entry of the results of the weekly administration of the Nonsense Word Fluency measure. The students' scores from the most recent Benchmark Period are displayed and weekly assessment results are entered for the lowest-performing readers. Medium-performing readers are re-assessed monthly, rather than weekly, and the results of those assessments also are entered using the screen depicted in FIG. 4B.

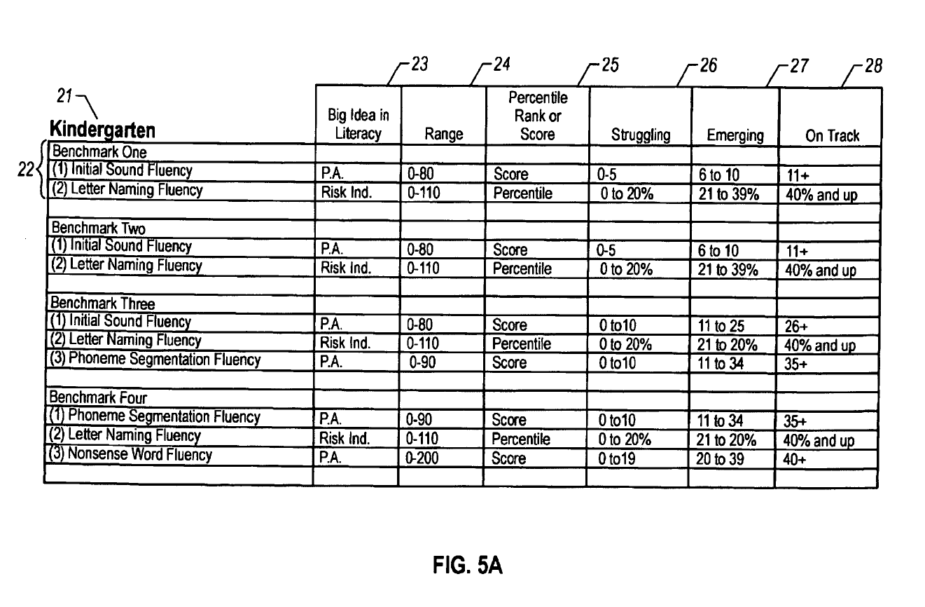

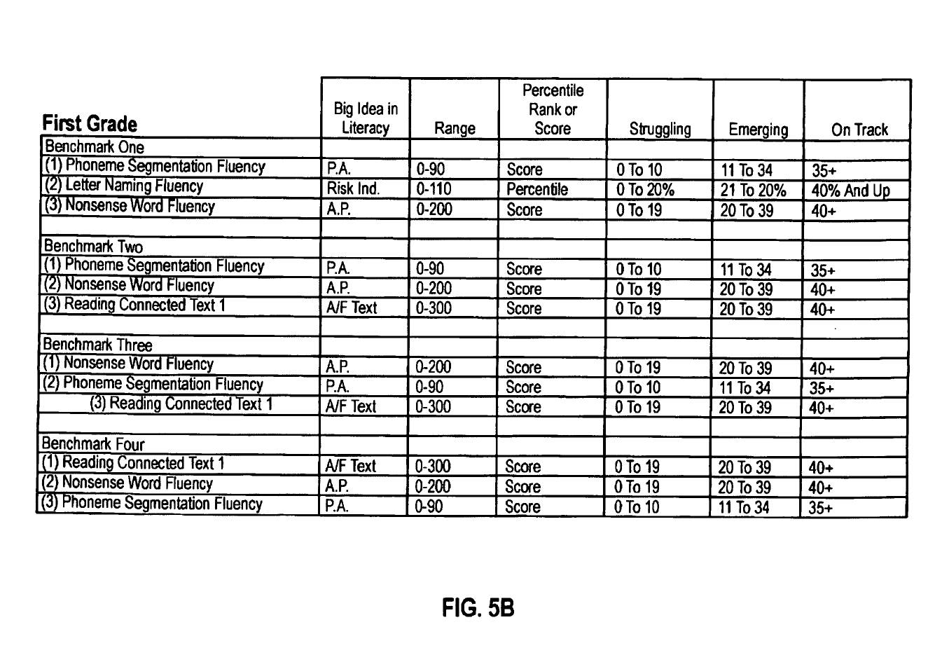

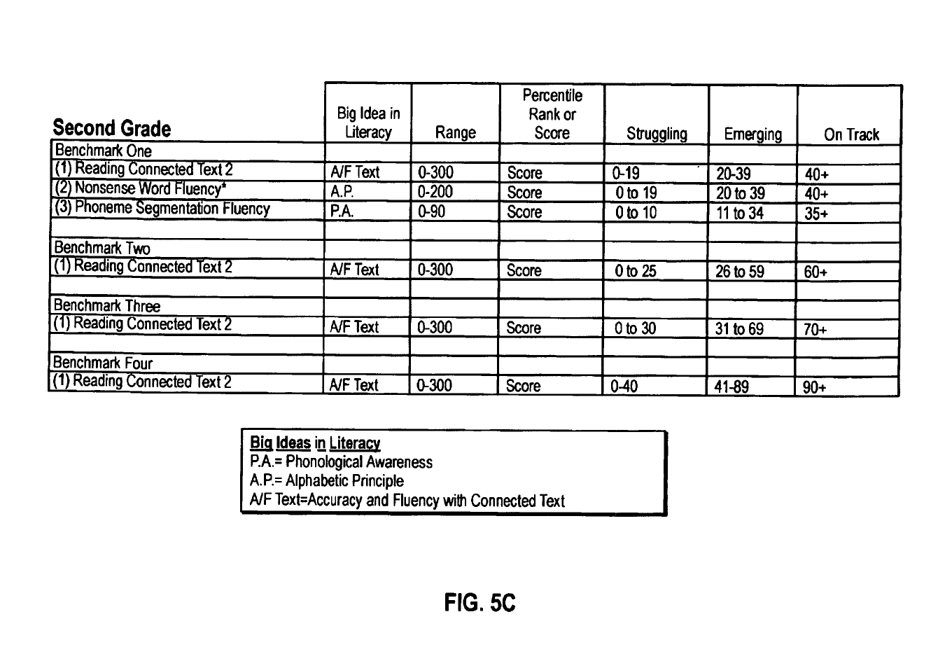

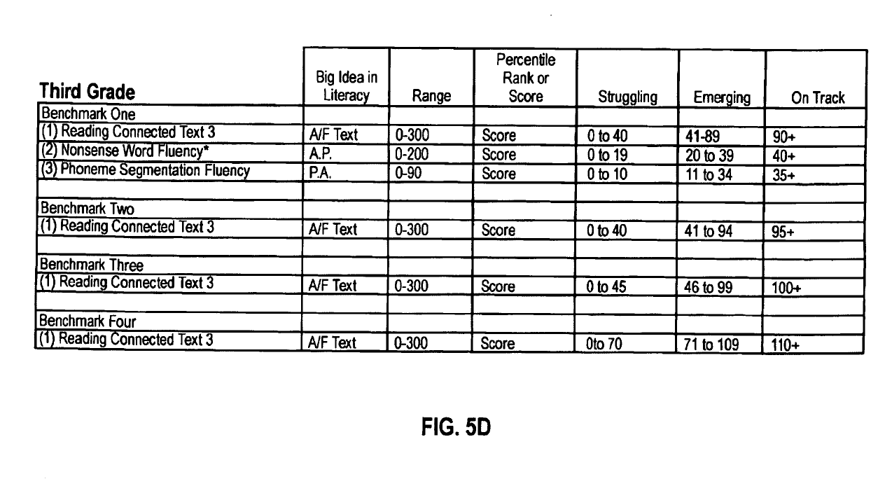

FIGS. 5A, 5B, 5C and 5D depict tables used for kindergarten, first, second and third grades, respectively, to calculate a measure of literacy from each of the oral fluency assessments results entered by the teacher. For each grade level 21, and for each benchmark period, of which benchmark 22 is an example, the table presents literacy indicators 23 identifying the reading skill assessed by each of the oral fluency measures included in the benchmark, a range 24 of possible assessment results for each fluency assessment, the type of result 25 returned by each oral fluency assessment, and result ranges 26, 27 and 28 for identifying lower-, medium- and higher-performing readers. Examination of these result ranges will reveal that the assessment scores needed to remain at the same measured level of literacy rise, in expectation of improving literacy throughout the school year.

To illustrate the use of the tables of FIG. 5A, benchmark 22 is described in more detail. Benchmarks one, two, three and four for kindergarten students comprise two oral fluency measures: Initial Sound Fluency and Letter Naming Fluency. Benchmark three further comprises Phoneme Segmentation Fluency while Benchmark four further comprises Nonsense Word Fluency. Referring to literacy indicators 23, those fluency measures assess for Phonological Awareness and provide a risk indicator for difficulty in acquiring crucial reading skills, respectively. The range 24 of scores achievable on the Initial Sound Fluency and Letter Naming Fluency measures is 0-80 and 0-110 respectively. Those result types 25 may be a raw score or a percentile, respectively. The result ranges 26, 27 and 28 provide a lookup table for calculating a measure of literacy from each of the fluency assessment scores. For the Initial Sound Fluency measure, scores in the ranges 0-5, 6-10, and 11-80 are assigned literacy levels Struggling, Emerging, and On Track, respectively. For the Letter Naming Fluency risk indicator measure, scores in the percentile ranges 0-20%, 21-39%, and 40-110% are assigned literacy levels Struggling, Emerging, and On Track, respectively. These two literacy measures are then weighted and combined to calculate a single level of literacy, also in the categories Struggling, Emerging, and On Track. However, these ranges, categories and measures are one exemplary embodiment and others may be utilized. FIGS. 5B, 5C and 5D depict similar tables for the first, second and third grade respectively. The benchmarks provided for the First, Second and Third grades further comprise measures for Reading Connected Text for each grade level.

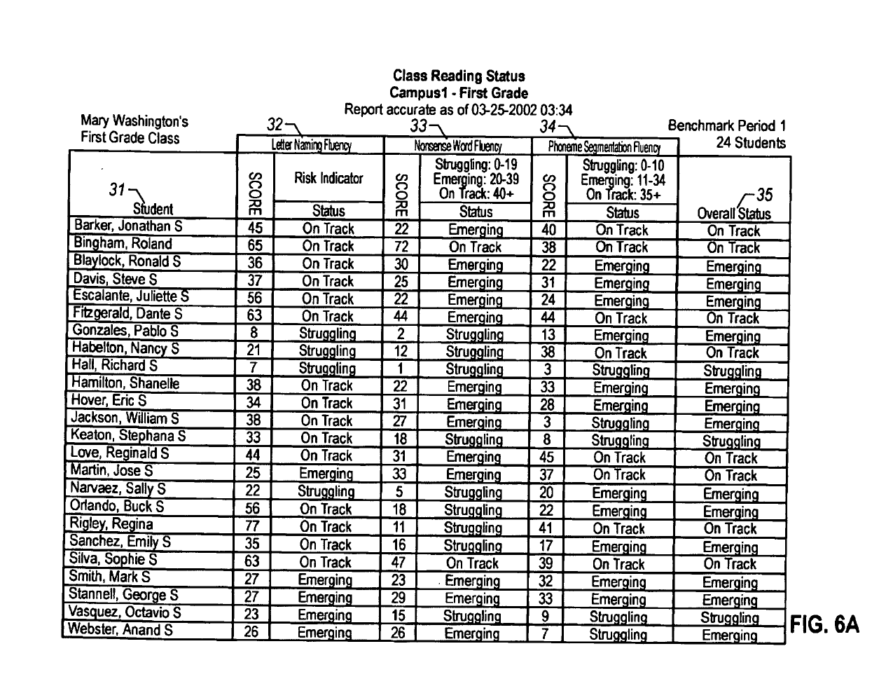

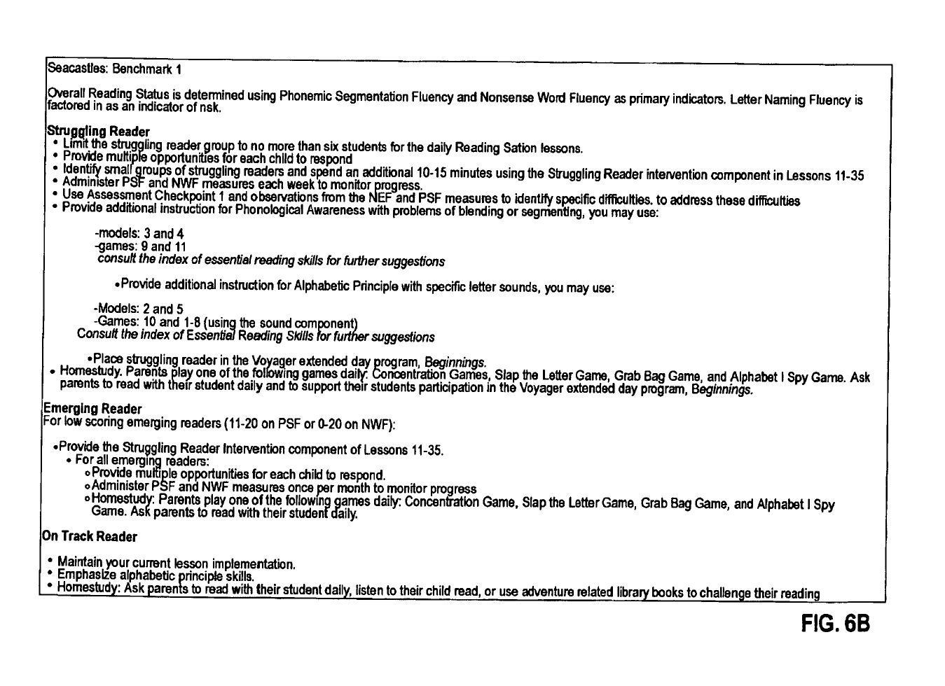

FIGS. 6A and 6B depict two parts of a class reading status report as presented by an embodiment of the present invention. In FIG. 6A, each student 31 is listed individually along with his or her fluency assessment results and literacy measures 32, 33 and 34, from, in this example, Benchmark Period 1. An overall predictive level of literacy 35, calculated from the student's assessment results, is also presented for each student. FIG. 6B shows curriculum and instruction time recommendations for lower-performing (Struggling), medium-performing (Emerging) and higher-performing (On Track) students, as produced by an embodiment of the present invention. For example, specific instructional recommendations are made for Struggling readers to spend additional instruction time on a specific Struggling Reader Intervention component in the curriculum, to administer Phoneme Segmentation Fluency and Nonsense Word Fluency assessments weekly, and to use specific Models and Games from the curriculum. Recommendations are made for low-scoring Emerging readers to use a specific Struggling Reader Intervention component in the curriculum and to administer Phoneme Segmentation Fluency and Nonsense Word Fluency assessments monthly.

A class reading status report such as that shown in FIGS. 6A and 6B would be used regularly throughout the school year by the teacher to monitor the literacy of the students and to adjust the students' curriculum and amount of instruction time, according to each student's level of literacy. Lower- and medium-performing students can be assessed and evaluated regularly between Benchmarks, allowing timely, targeted instructional intervention to ensure their achievement of grade-level literacy.

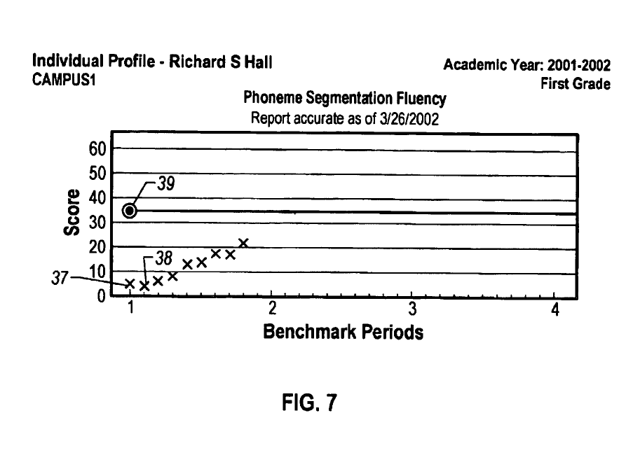

FIG. 7 depicts a timeline plot of benchmark and weekly progress monitoring results for an individual student for a single fluency assessment. Benchmark result 37 and weekly assessment results 38 are plotted on a timeline along with a grade level literacy target score 39, in order to show the student's progress toward grade-level literacy. Such a graphical presentation of assessment scores assists the teacher to determine whether the student is making satisfactory progress toward grade-level literacy.

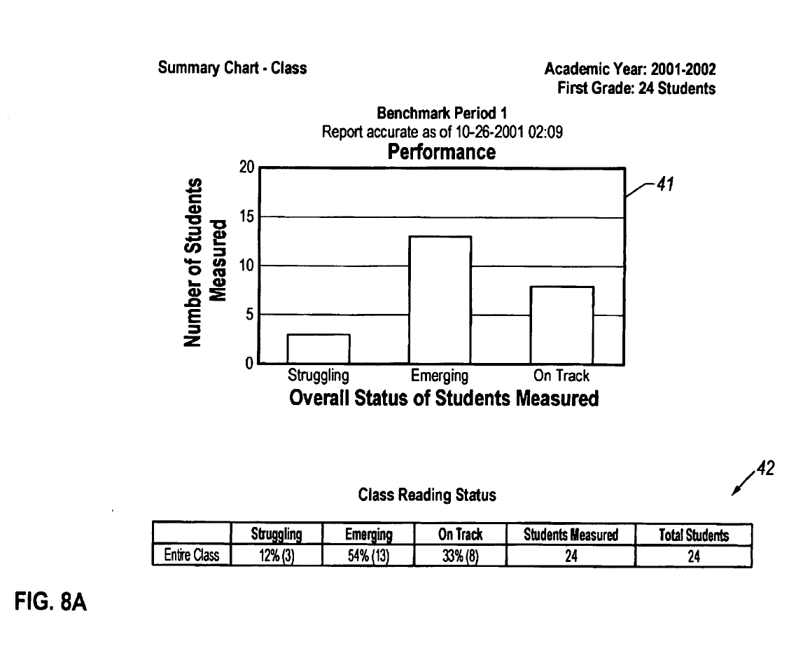

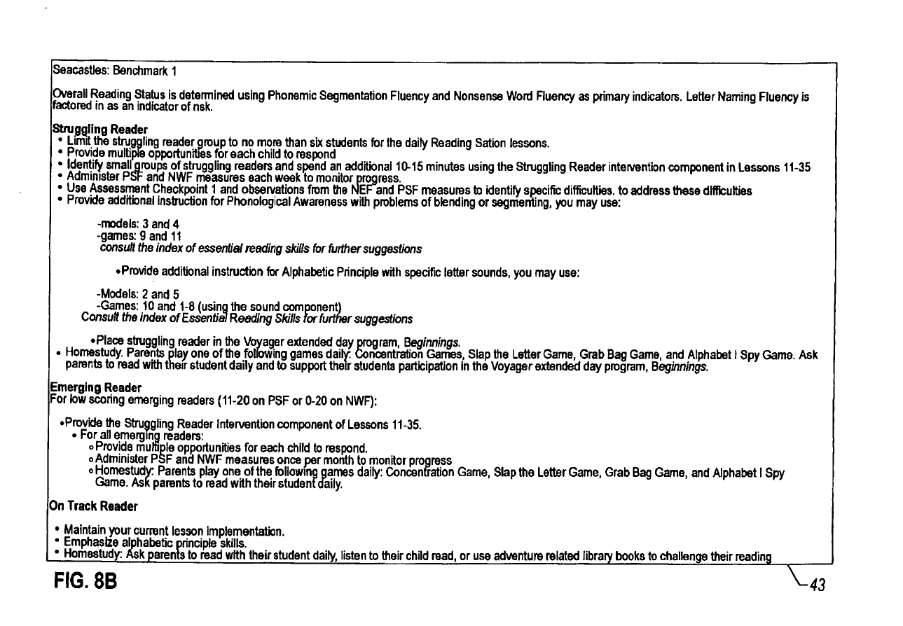

FIGS. 8A and 8B illustrate a summary chart for the class of students reported on in FIGS. 6A and 6B. This report aggregates the calculated predictive measures of literacy for all students in the class and presents the results in FIG. 8A as a bar chart 41 graphically depicting the number of students at each level of literacy and as a table of numeric data 42, numerically presenting the same information as the bar chart 41. Recommendations 43 for curriculum and instruction time, as described for FIG. 6B, are also presented in this report, as shown in FIG. 8B.

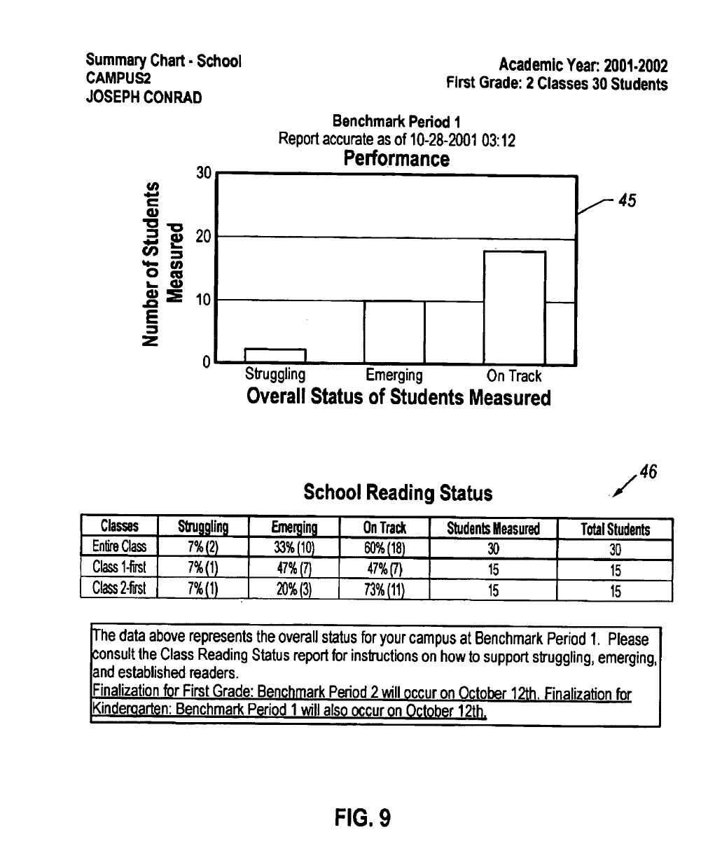

Measured levels of literacy can also be aggregated for all students within a school. FIG. 9 depicts such an aggregate report. The report presents a bar chart 45 graphically depicting the number of students in the school at each level of literacy and a table of numeric data 46, numerically presenting the same information as the bar chart 45. Table 46 also presents aggregated numerical information on the number of students at each level of literacy in individual classes within the school.

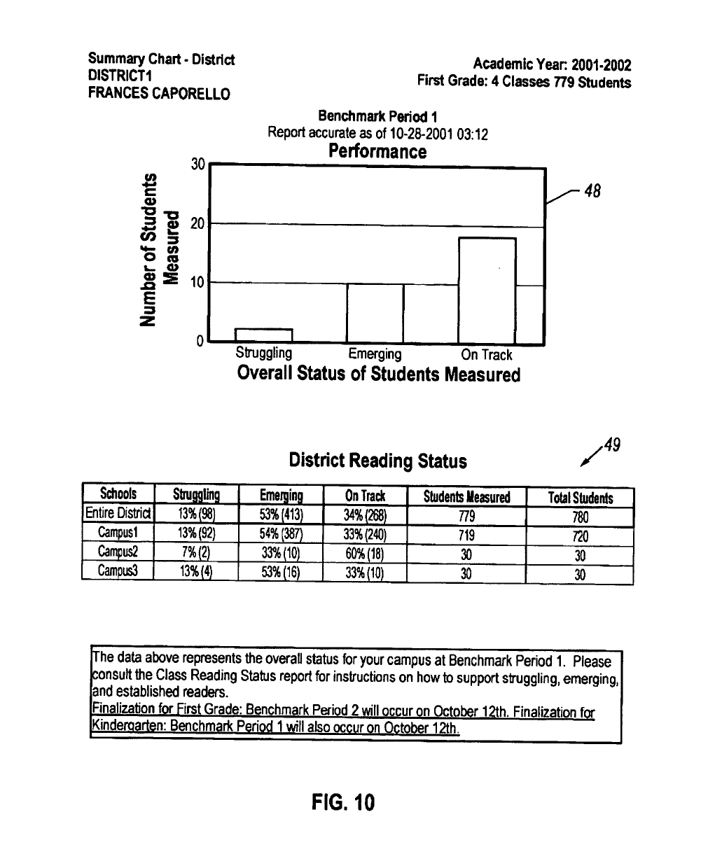

A similar summary chart is presented in FIG. 10 for all students within a school district. Again, a chart 48 graphically depicting the number of students in the district at each level of literacy and a table of numeric data 49, numerically presenting the same information as the chart 48, are presented summarizing the performance of the students. Table 49 also presents aggregated numerical information on the number of students at each level of literacy in individual schools within the district.

Monitoring the implementation of the method can increase the efficacy of the illiteracy prevention method of the present invention. In order to monitor and improve the implementation of the method, teachers and administrators are surveyed for information regarding their activities in implementing the method. The information collected in these surveys can then be presented to teachers and administrators to permit them to improve their implementation of the illiteracy prevention method. Data from the students is correlated and analyzed with data from the teachers and administrators, and provided in aggregate reports to provide early signs of low student progress and poor implementation of the method. Aggregate data is reported, showing a summary of the progress of implementation of the method in the classrooms. A report is included that provides recommendations for each classroom to prevent illiteracy. Information on the pacing of the curriculum in each classroom is collected and presented. Information on the plans and actions for students who need additional instruction time and support is recorded and reported on. Information on the quality and fidelity of the implementation of the system are recorded and reported on. Recommendations are made to teachers for improving their implementation of the method.

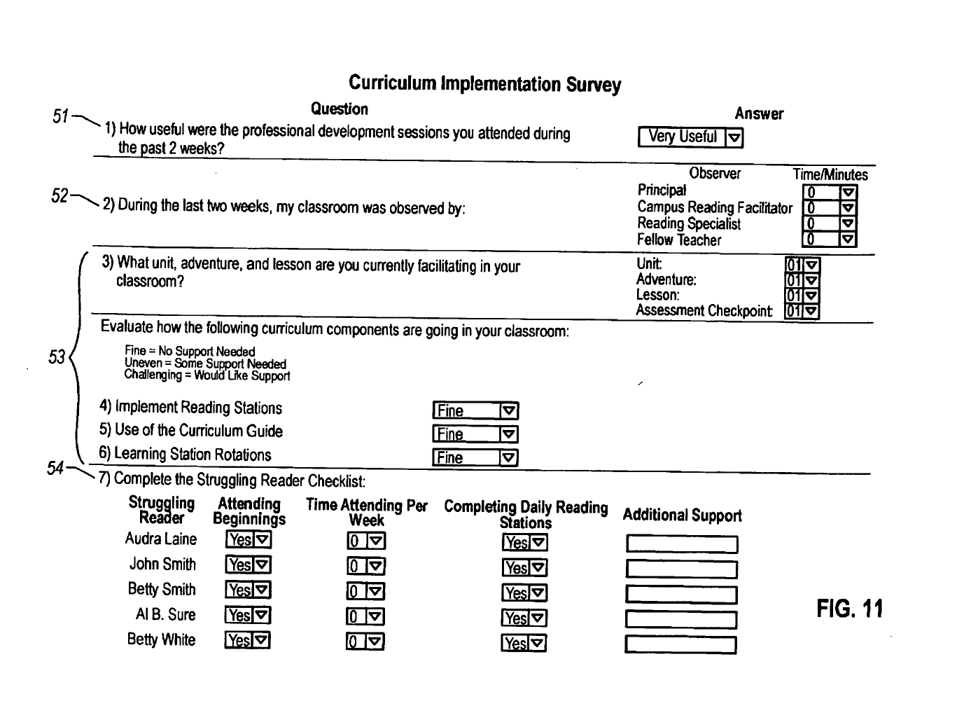

FIG. 11 illustrates a teacher's survey as used in an embodiment of the present invention. The survey collects information regarding professional development activities by the teacher 51, such as the utility of professional development sessions attended. In this embodiment, pop-down menus are used to select an answer to the survey question, indicated in the figure by a box around the response and an inverted triangle next to the response box. Supervisory activities by administrative personnel 52 are also gathered by the form, for example, the number of observation visits received by the teacher from different categories of administrators. Further, information on implementation activities 53 by the teacher is sought, such as the elements of the curriculum currently being taught in the class and a self-assessment of the teacher's use of curriculum components. Information 54 on activities completed by lower-performing students is also collected on the form, for example, their attendance at extended instruction sessions and their completion of additional curriculum components.

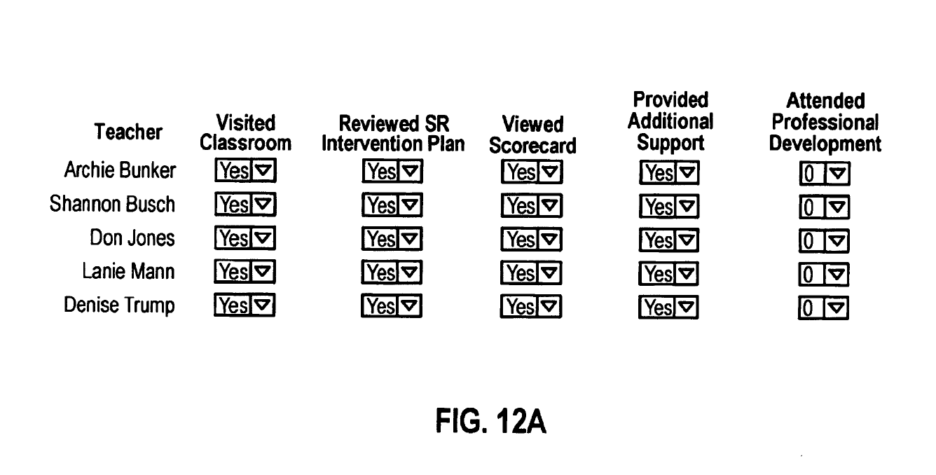

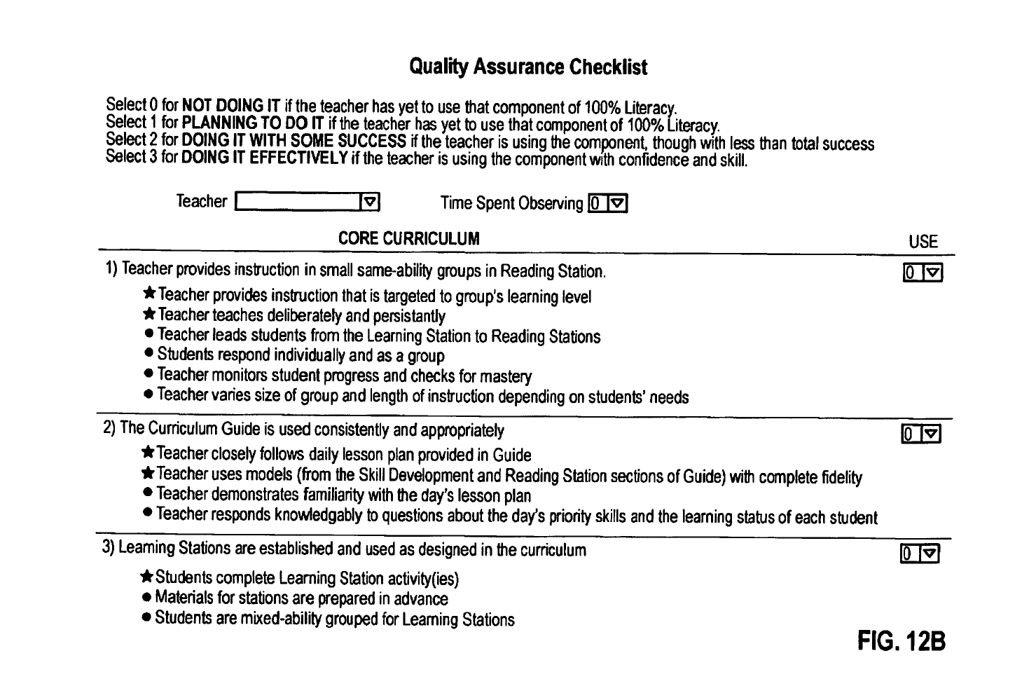

FIGS. 12A and 12B depict forms for collecting information from supervisors of the implementers of the illiteracy prevention method. FIG. 12A collects information regarding the supervisor's recent activities in support of individual teachers: in this embodiment of the invention, that information includes whether the supervisor visited the teacher's classroom, reviewed the teacher's intervention plan for lower-performing or struggling readers, viewed the teacher's implementation report. The information collected in the supervisor's survey in this embodiment of the invention also includes a report by the supervisor of the teacher's attendance at professional development sessions. FIG. 12B illustrates a form for recording observations made by the supervisor while observing individual teachers in a classroom setting. In this embodiment, the observations recorded are of the teacher's use of the Reading Station, Curriculum Guide and Learning Station instructional components.

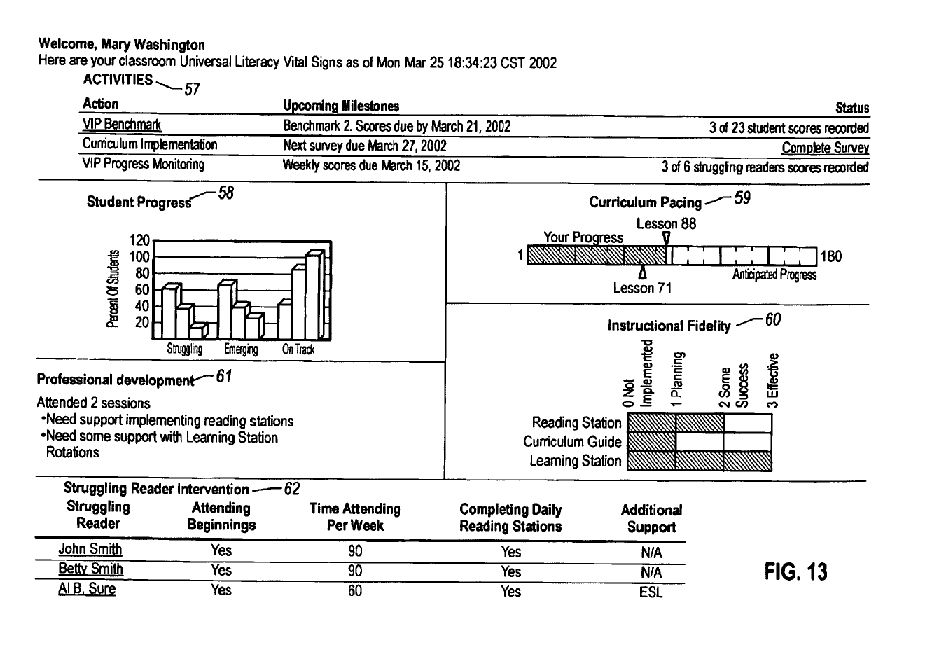

Once the survey information from FIGS. 11, 12A and 12B is entered into the database of an embodiment of the present invention, an implementation report such as that shown in FIG. 13 can be presented to the teacher. Included in this embodiment of such a report are a summary of implementation activities 57, such as administration of Benchmarks and weekly progress monitoring assessments, and timely completion of the teacher survey form. Aggregated information on the students' calculated predictive measures of literacy 58 is also presented in the implementation report. Such aggregated information in this embodiment of the invention includes a bar chart depicting the number of students at each level of literacy in several recent Benchmark Periods, allowing the teacher to observe the increase or decrease of number of students at each level of literacy. A graphical presentation of the teacher's instructional pacing 59 is also presented, showing the amount of curriculum the teacher is expected to have completed by the date of the report, juxtaposed with the amount of curriculum the teacher has actually completed. Further, a graphical presentation 60 of a supervisor's assessment of the teacher's use of the instructional components recorded in the form from FIG. 12B is included in the implementation report, as an indicator of instructional fidelity. A summary of recent professional development activities 61 is presented. Additionally, information on remediation activities completed by each lower-performing student 62 is included in the implementation report, including the student's attendance at extended instruction time sessions, and the amount of time attending those sessions, and the student's completion of daily reading assignments.

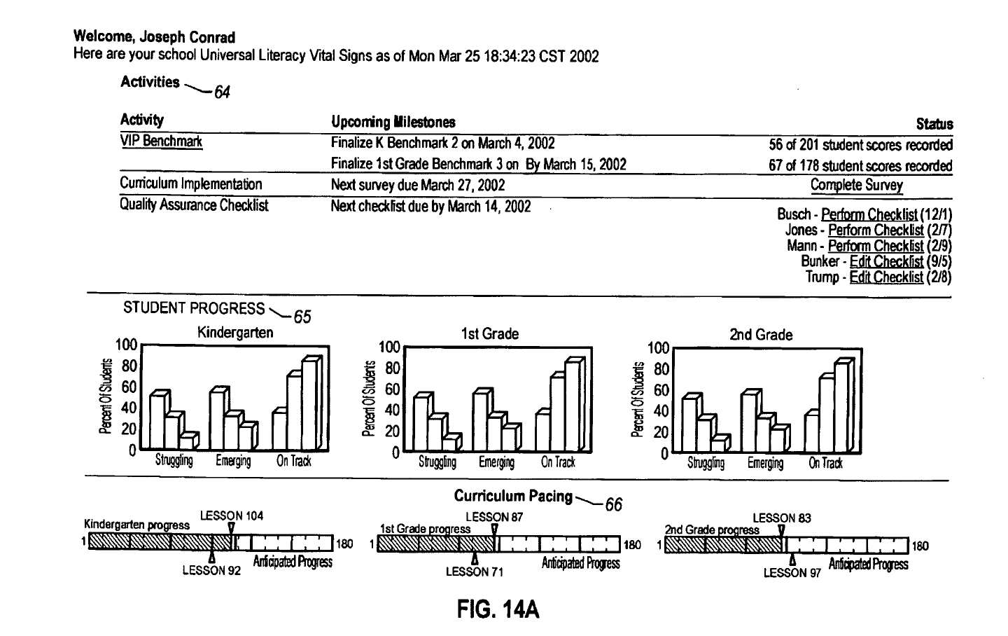

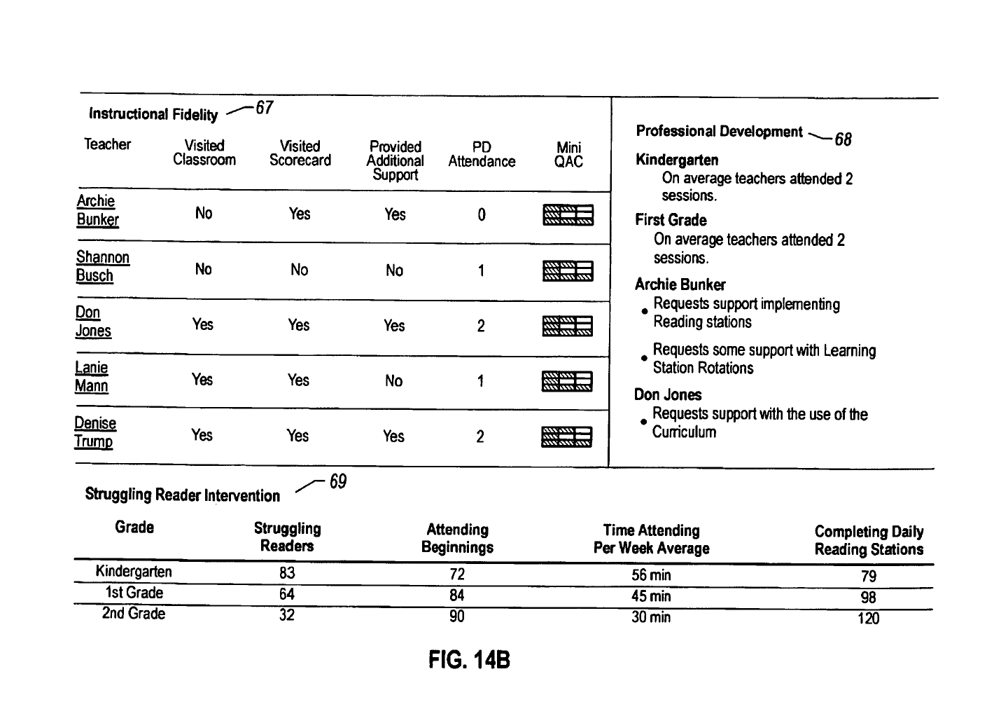

In this embodiment of the present invention, a report such as that shown in FIGS. 14A and 14B can be prepared for a supervisor at the school level. Turning to FIG. 14A, information presented in such a report in this embodiment of the invention includes a table of summarized implementation activities 64 for all classes and teachers in the school, including upcoming milestone deadlines and the degree of teachers' completion of milestones and of the supervisor's completion of the milestones. Aggregated student progress information 65 for each grade level in the school is also presented in the form of a bar chart depicting the number of students at each level of literacy in several recent Benchmark Periods, as described for FIG. 13. Aggregated instructional pacing information 66 is presented graphically in this embodiment of the invention, as described for the presentation of the teacher's instructional pacing 59 in FIG. 13. Turning to FIG. 14B, the report also includes instructional fidelity information 67, as reported by the supervisor in the survey forms of FIGS. 12A and 12B, for each teacher in the school. In order to clarify the results reported for a specific teacher, the supervisor can click on that teacher's name and review details of that teacher's class, for example, a report such as that shown in FIG. 13. Professional development information 68 is also presented, aggregated for each grade level and listing needs reported by individual teachers. Information 69 regarding remediation activities completed by lower-performing students is shown, aggregated by grade level, including the number of lower-performing students in each grade level, the number of students attending extended instruction time sessions, the average amount of time spent attending those sessions, and the number of students completing daily reading assignments.

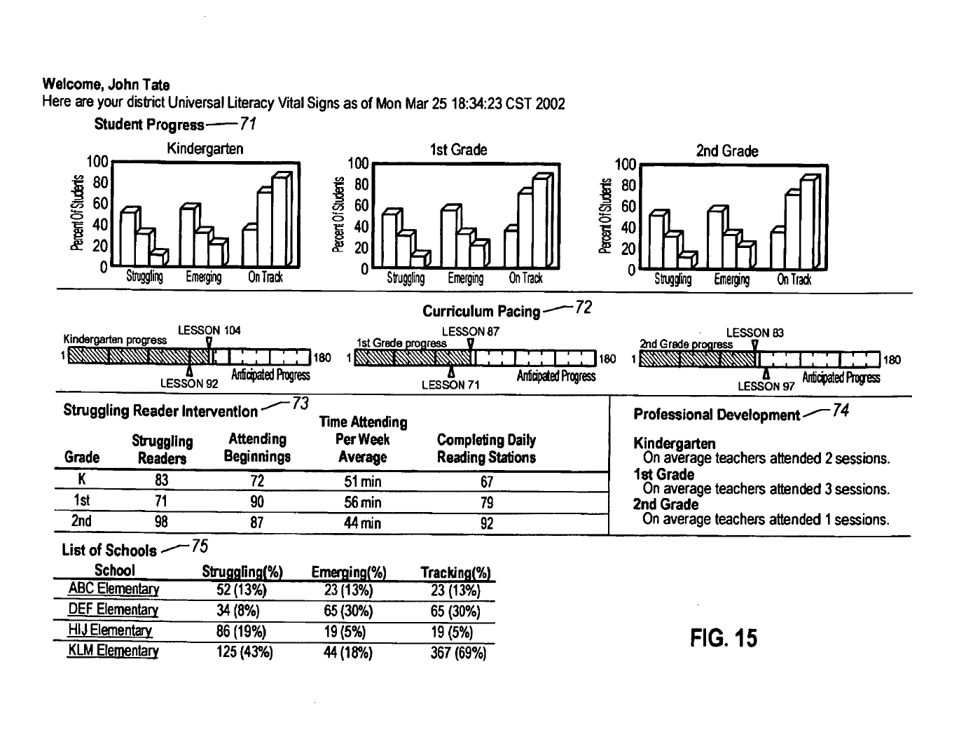

FIG. 15 depicts a report for a district level supervisor, including aggregated student progress information 71 by grade level for all students in the school district, presented as described for aggregated student progress information 65 in FIG. 14A. Instructional pacing information 72 is aggregated for each grade level in the district and presented, in this embodiment of the invention, in the same format described for aggregated instructional pacing information 66 in FIG. 14A. Information 73 regarding remediation activities completed by lower-performing students in the district is shown, aggregated by grade level, including the number of lower-performing students in each grade level, the number of students attending extended instruction time sessions, the average amount of time spent attending those sessions, and the number of students completing daily reading assignments. Aggregated professional development information 74 for teachers at each grade level within the district is also presented, including the average number of professional development sessions attended. Additionally, a table of aggregated measures of literacy 75 is included, showing, in this embodiment of the invention, the number and percentage of students at each level of literacy at each school in the district. Details of performance at a specific school can be viewed by clicking on the school name, which brings up a report on that school, for example, a report such as that shown in FIGS. 14A & 14B.

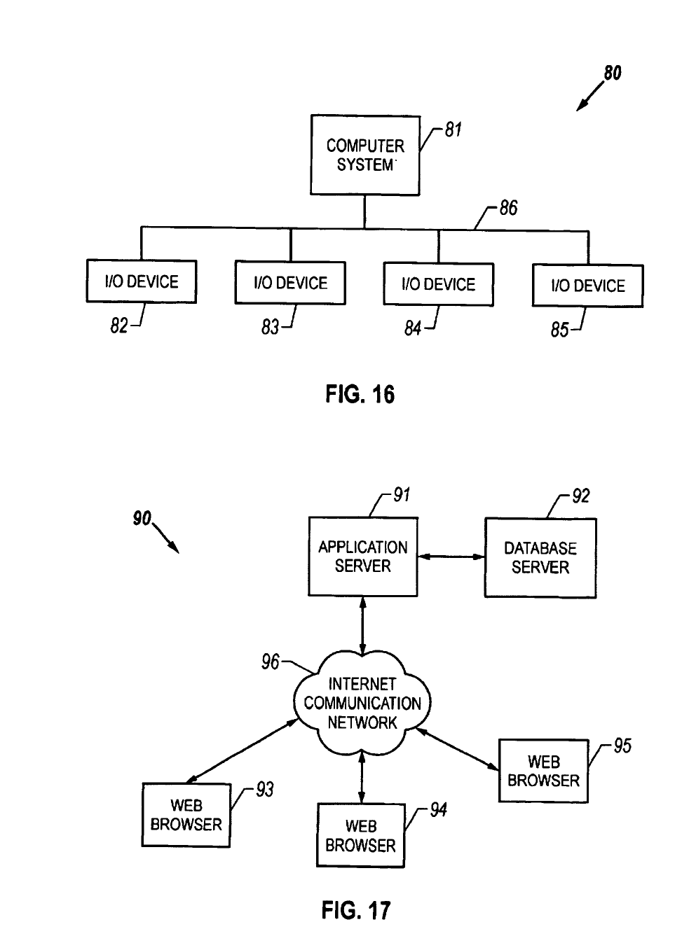

FIG. 16 depicts a computer network 80 which may be used to implement an embodiment of the present invention. Computer system 81, having processing and storage capabilities, is connected to input/output devices 82, 83, 84 and 85 by communication network 86. Input/output devices 82, 83, 84 and 85 may be personal computers used by teachers and administrators to enter information into the database of an embodiment of the present invention or to view reports produced by the computer implementing an embodiment of the illiteracy prevention method. Entered information is stored in the computer system 81, and predictive measures of literacy and aggregated information for reporting purposes are calculated in the computer system 81.

FIG. 17 illustrates an alternative embodiment of the present invention. Internet-based computer system 90 includes application server 91 in communication with data base server 92 and with the Internet communication network 96. Web browsers 93, 94 and 95 communicate with the application server 91 via the Internet communication network 96. In this embodiment of the illiteracy prevention method, stored information is kept in data base server 92, calculations required to calculate measures of literacy and to aggregate information for reporting purposes are performed by application server 91. Teachers and supervisors may use web browsers 93, 94 and 95 to input data into the system and to view reports created by the system. In another embodiment, communication network 96 could be an intranet connecting only computers and browsers within the school district.

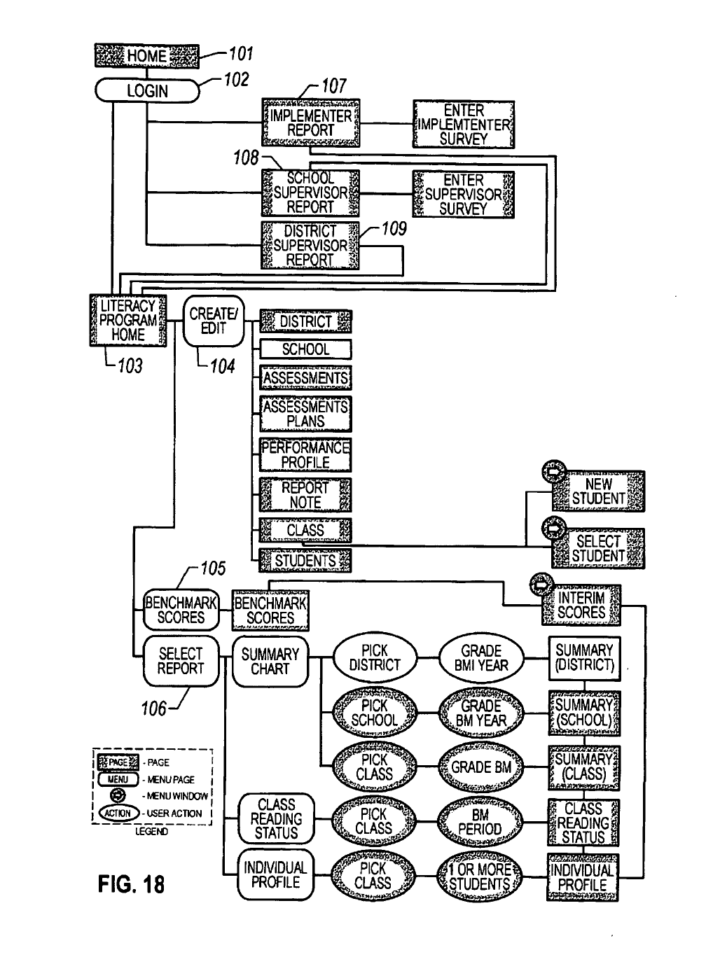

FIG. 18 depicts some of the screens used by an embodiment of the present invention. From home screen 101 the user can execute login actions 102, which results in access to the literacy system home page 103. From this page the user can execute menu items to access other sections of the literacy system. The Create/Edit menu item 104 may be used to create database entries for the students, classes, schools, and district monitored by the literacy system. The Benchmark Scores menu item 105 may be used to access screens for entering benchmark oral fluency assessment results and weekly progress monitoring assessment results. The Select Report menu item 106 may be used to view Summary Charts containing aggregated summary information about classes, schools and the school district; Class Reading Status screens presenting information about classes; and Individual Profile screens showing information about individual students. From login actions 102, the user can also access implementer report screen 107, school supervisor report screen 108 and district supervisor report screen 109 and the screens used to enter the survey information that goes into those reports. The user can also access literacy system home page 103 from implementer report screen 107 and school supervisor report screen 108.

This information on student progress and classroom implementation is causally related and is analyzed and correlated to trigger action steps to prevent illiteracy. As such, a method and system for achieving grade-level literacy in substantially all members of a predetermined set of students is described. However, the method may be extended to other subjects, activities, and teaching goals. Further the method may be extended to various grades, classes, and learning levels, among others.

The following examples illustrate alternate embodiments of the invention but, of course, should not be construed as in any way limiting its scope.

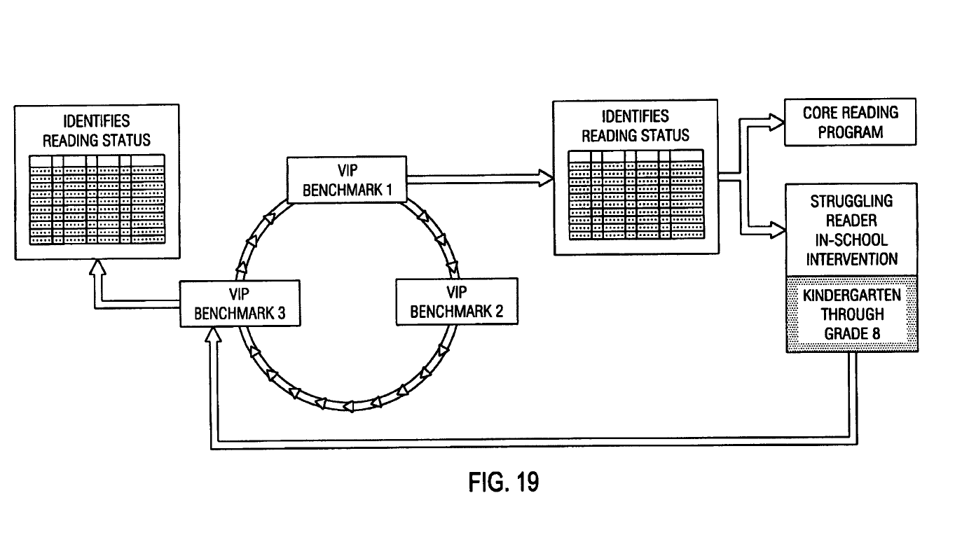

FIG. 19 depicts a method and system to accelerate struggling readers, representing an embodiment of the present invention. This method and system integrates with any reading program, targets all struggling readers who fall behind, and combines research-based intervention curriculum and a proven progress monitoring system to accelerate struggling readers to grade level proficiency. FIG. 19 shows Kindergarten through Grade 8 as an example of implementation of the present invention, but as throughout the present disclosure, specification of grades K-8 serve only to illustrate possible implementation of the application, and other grade levels and groupings of grade levels are within the purview of the presently claimed invention, as would be understood by those skilled in the art.

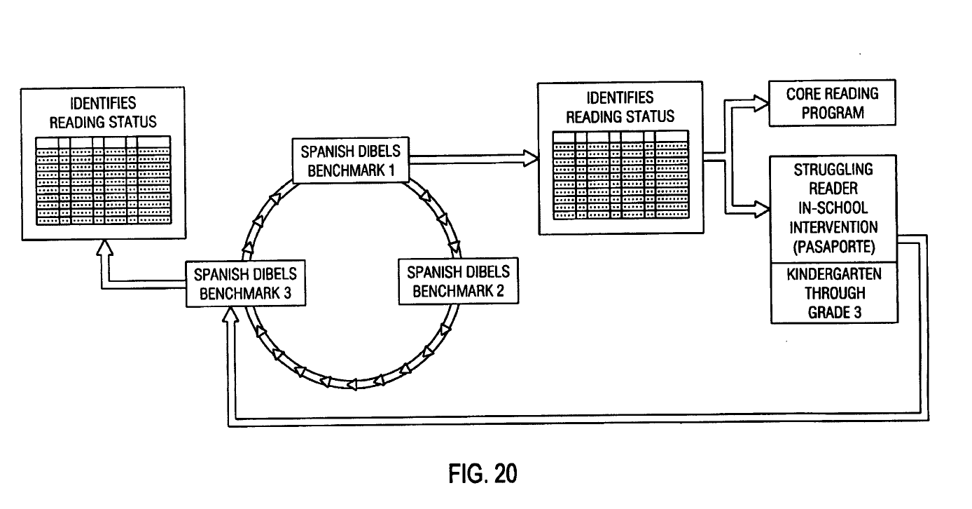

The method and system of the present invention have been largely depicted using exemplary embodiments written entirely in the English language. Alternately, embodiments of the present invention can be written in any language or any combination of languages. For example, FIG. 20 depicts the use of Spanish DIBELS™ in order to prevent illiteracy in Spanish-speaking struggling readers. Grades K-3 are shown for illustration purposes only, and are not intended to be limiting.

This method and system was created for struggling students, including a daily 30-40 minute targeted reading intervention curriculum designed to supplement current reading programs. It provides targeted skill development in phonics, fluency, phonemic awareness, vocabulary, comprehension, and spelling.

The system includes a progress monitoring system. The progress monitoring system ensures that struggling readers are identified and diagnosed, so the specific help they need can be provided.

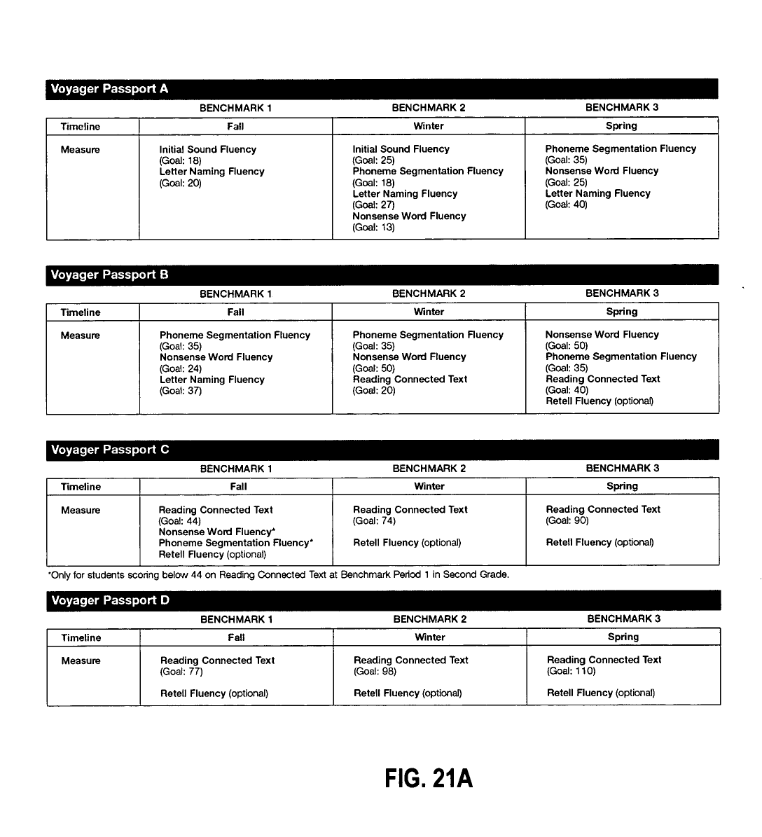

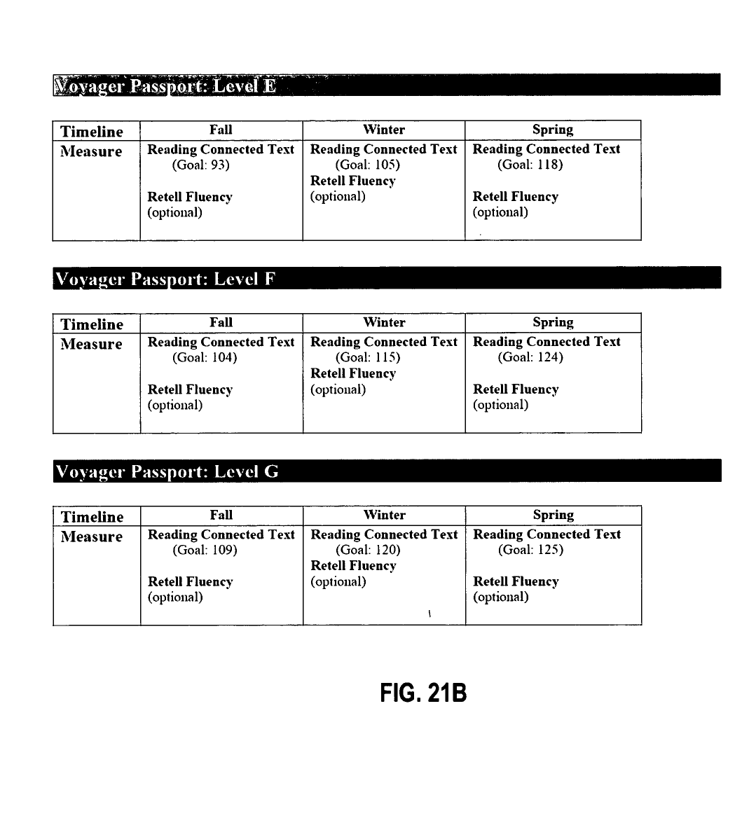

FIGS. 21A and 21B depict progress monitoring benchmarks for implementations of an illiteracy prevention system at seven levels, in accordance with an embodiment of the present invention. Each benchmark provides a standardized performance measure of progress on critical reading skills. The benchmark schedules of FIGS. 21A and 21B identify each assessment, when it is administered, and the scores establishing reading proficiency. For example, first graders who reach the goal of reading 40 words per minute accurately and fluently at Benchmark 3 are considered on track. The benchmarks of FIGS. 21A and 21B correspond to the system of FIG. 19. Analogously, benchmarks which correspond to the system of FIG. 20 exist but are not shown in an accompanying figure.

The system provides science-based intervention instruction, reliable assessment, and professional training in the use of the system.

Three aspects of the system are that it identifies all of the struggling readers left behind by most reading programs (often 20-40% of readers); provides targeted intervention instruction to advance these students to grade level; and tracks their progress through the progress monitoring system to measure critical reading skills in individual students. The system includes targeted instruction in phonemic awareness, phonics, fluency, comprehension, and vocabulary.

The intervention system can be integrated into a reading program currently implemented in a school. The intervention system enhances such a current reading program and does not replace it.

Students identified as struggling readers through the progress monitoring system are provided systematic, explicit instruction to target each student's specific needs.

Ongoing progress monitoring is included to ensure each student's progress toward grade level proficiency goals to ensure reading success. Teachers periodically administer one-minute oral fluency assessments, enter the data on the progress monitoring system Internet screen, and receive a quick analysis and instructional recommendations on how to adjust curriculum for each student's progress.

Accordingly, the system is suitable for enhancing all reading programs, rather than replacing such programs. The system focuses on preventing illiteracy in those students who are struggling under the existing reading program, rather than those students who are excelling under the existing program. As a modular addition to an existing reading program, this system is easier to implement than undertaking structural modification and redesigning of the existing reading program.

The system methodically and effectively improves reading skills as a direct result of its systematic nature. An element of the system is provision of immediate and ongoing analysis of each student's reading progress.

The system significantly accelerates the academic growth of low-performing students by applying the ULS system described by U.S. Pat. No. 6,676,413 specifically to a subset of students who are struggling, and is based on the proven success of the struggling reader intervention component of the above-described method and system for preventing illiteracy in substantially all members of a predetermined set of students.

The term “visual medium” as used herein means any medium having utility in presenting information visually, such as paper, computer display, etc.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for identifying a set of students who have encountered reading difficulty and are performing below grade level and providing for intervention to prevent illiteracy and achieving grade-level literacy of struggling students, comprising the steps of:
administering at least one standardized oral fluency assessment for a predetermined set of at least one student;
recording a plurality of results from said at least one standardized oral fluency assessment for each student of said predetermined set in a database in a computer system;
calculating on said computer system a standardized predictive measure of literacy for said each student, wherein said standardized predictive measure of literacy is a composite of said results stored in said database for said each student;
identifying struggling members of said predetermined set based on each said standardized predictive measure of literacy;
presenting an individual report for each said struggling member on a visual medium in communication with said computer system, said individual report comprising:
said results for said struggling member stored in said database;
said standardized predictive measure of literacy for said struggling member; and
recommendations of targeted intervention curriculum and amount of instructional time for said struggling member, based on said standardized predictive measure of literacy for said struggling member.

2. The method of claim 1, further comprising the steps of:
determining a schedule for performing said step of administering said at least one standardized oral fluency assessment for said predetermined set of at least one student in said database in said computer system, based on said standardized predictive measure of literacy for each said struggling member; and
repeating the steps of administering, recording, calculating, presenting an individual report, determining according to said schedule, and providing targeted intervention instruction and amount of instruction and whereby grade-level literacy is achieved in said struggling members of said predetermined set of students.

3. The method of claim 1, wherein the step of administering at least one standardized oral fluency assessment for said predetermined set of at least one student comprises the step of:
administering a plurality of standardized oral fluency assessments for said predetermined set of at least one student.

4. The method of claim 3, wherein said step of administering said plurality of standardized oral fluency assessments for said predetermined set of at least one student comprises the step of:
administering a plurality of standardized one-minute oral fluency assessments for said predetermined set of at least one student.

5. The method of claim 1, wherein said step of recording results from said at least one standardized oral fluency assessment for each student of said predetermined set in said database in said computer system comprises:
receiving a plurality of results from a plurality of standardized oral fluency assessments for each student of said predetermined set via a full-time public network, said plurality of results having been entered via a user interface to a full-time public network; and
recording the plurality of results from said plurality of standardized oral fluency assessments for each student of said predetermined set in said database in said computer system.

6. The method of claim 1, further comprising the step of:
presenting an aggregate report on a visual medium in communication with said computer system summarizing said standardized predictive measure of literacy for said struggling members.

7. The method of claim 1, wherein said step of presenting said individual report for each said struggling member on said visual medium in communication with said computer system comprises the step of:
plotting a timeline of said results from each of said plurality of standardized oral fluency assessments recorded for each said struggling member.

8. The method of claim 1, wherein said visual medium comprises a display in communication with said computing system via a full-time public network.

9. The method of claim 1, wherein said step of administering said plurality of standardized oral fluency assessments for said predetermined set of at least one student comprises the step of:
administering a plurality of standardized Spanish-Language oral fluency assessments for said predetermined set of at least one student.

10. The method of claim 7, wherein said step of administering at least one standardized oral fluency assessment for said predetermined set of at least one student comprises the step of:
administering at least one standardized Spanish-Language oral fluency assessment for said predetermined set of at least one student.

11. A system for identifying a set of students who have encountered reading difficulty and are performing below grade level and providing for intervention to prevent illiteracy and achieving grade-level literacy of said struggling students, comprising:
at least one standardized oral fluency assessment;
a computer system, comprising:
a database for storing results of administering said at least one standardized oral fluency assessment to a predetermined set of at least one student;
calculation instructions for calculating a standardized predictive measure of literacy for said each student, wherein said standardized predictive measure of literacy is a composite of said results stored in said database for said each student;
identification instructions for identifying struggling members of said predetermined set based on each said standardized predictive measure of literacy;
recommendation instructions for recommending curriculum and amount of instruction time for each said struggling member, based on said standardized predictive measure of literacy for said struggling member; and
scheduling instructions for determining a schedule for administering said at least one standardized oral fluency assessment for said struggling members;
at least one input device in communication with said computer system for inputting said results; and
at least one output device in communication with said computer system for outputting said results, said measure of literacy, said recommendation of intervention curriculum and amount of instruction time, and said schedule.

12. The system of claim 11, wherein said at least one standardized oral fluency assessment comprises:
at least one standardized one-minute oral fluency assessment.

13. The system of claim 11, wherein said at least one input device in communication with said computer system for inputting said results comprises:
at least one input device in communication with said computer system via a full-time public network for inputting said results.

14. The system of claim 11, wherein said computer system further comprises:
aggregation instructions for aggregating said standardized predictive measures of literacy for said struggling members.

15. The system of claim 11, wherein said computer system further comprises:
plotting instructions for plotting a timeline of said results from each of said at least one standardized oral fluency assessment stored in said database for each said struggling member.

16. The system of claim 11, wherein said at least one output device in communication with said computer system for outputting said results, said measure of literacy, said intervention curriculum and amount of instruction time, and said schedule comprises:
at least one output device in communication with said computer system via a full-time public network for outputting said results, said measure of literacy, said recommendation of curriculum and amount of instruction time, and said schedule.ABC

17. The system of claim 11, wherein said at least one standardized oral fluency assessment comprises:
at least one standardized Spanish-Language oral fluency assessment.

18. A method for identifying a set of struggling students, comprising the steps of:
requesting a plurality of results of a plurality of standardized oral fluency assessments corresponding to a set of struggling students;
receiving said plurality of results of said plurality of standardized oral fluency assessments corresponding to said set of struggling students;
entering said plurality of results via an input device in communication with a computer system having a database, thereby facilitating the recording of said results in said database in said computer system;
receiving via a visual medium in communication with said computer system an individual report for each said struggling member, said individual report comprising:
said plurality of results for said struggling member stored in said database;
a standardized predictive measure of literacy for said struggling member, wherein said standardized predictive measure of literacy is a composite of said results; and
specific recommendations of intervention curriculum and amount of instruction time for said struggling member, based on said standardized predictive measure of literacy for said struggling member; and
determining a schedule for performing said step of requesting said results of said plurality of standardized oral fluency assessments for said set of struggling students, based on said standardized predictive measure of literacy for each said struggling member;
repeating the steps of requesting, receiving said plurality of results, entering, receiving via a visual medium, determining according to said schedule, and providing targeted intervention instruction whereby grade-level literacy is achieved in said struggling students.

19. The method of claim 18, wherein said step of requesting a plurality of results of a plurality of standardized oral fluency assessments corresponding to a set of struggling students comprises the step of:
requesting a plurality of results of a plurality of standardized one-minute oral fluency assessments corresponding to a set of struggling students.

20. The method of claim 18, wherein said step of entering said plurality of results via an input device in communication with a computer system having a database, thereby facilitating the recording of said results in said database in said computer system comprises:
entering said plurality of results via an input device in communication via a full-time public network with a computer system having a database, thereby facilitating the recording of said results in said database in said computer system.

21. The method of claim 18, wherein said step of receiving via a visual medium in communication with said computer system an individual report for each said struggling member, said individual report comprises the step of:
receiving via a visual medium in communication with said computer system an aggregate report summarizing said standardized predictive measure of literacy for said struggling members.

22. The method of claim 18, wherein said visual medium comprises a display in communication with said computing system via a full-time public network.

23. The method of claim 18, wherein said step of requesting the plurality of results of the plurality of standardized oral fluency assessments corresponding to the set of struggling students comprises the step of:
requesting a plurality of results of a plurality of standardized Spanish-Language oral fluency assessments corresponding to a set of struggling students.
